(19) United States
(12) Patent Application Publication
(10) Pub. No.: US 2002/0144239 A1
(43) Pub. Date: Oct. 3, 2002

(54) Method and system for modifying data in foreign formats

(76) Inventor: Ray Bentley, Elverson, PA (US)

Correspondence Address: VENABLE, BAETJER, HOWARD & CIVILETTI, LLP, Post Office Box 34385, Washington, DC, 20043-9998, US

(21) Appl. No.: 09/820,891

(22) Filed: Mar. 30, 2001

(51) Int. Cl. G06F 9/455

(52) U.S. Cl. 717/136

(57) ABSTRACT

A user of a native system desires to work with a foreign file containing data in a foreign format. To do so, the foreign file in the foreign format is converted into native file a native format. Data in the foreign file that is not representable in the native format should be preserved. Translation of the data into the native format allows the data to be manipulated, edited, changed, etc. by the native system. Any alterations made to the data using the native system can be tracked, for example, by creating a list of changes. The foreign file can be updated to reflect these alterations by directly changing the foreign file, rather than by attempting to recreate the foreign file from the altered or edited native file.

### FIELD OF THE INVENTION

The present invention relates generally to a system and method for converting data between different formats, and more specifically to computer-aided design (CAD) software that may edit data provided in a foreign format.

### BACKGROUND OF THE INVENTION

CAD software is well-known, and used by architects, engineers, artists, and the like to create precision drawings and technical illustrations. It is used to create two-dimensional (2-D) drawings and three-dimensional (3-D) models. Applications such as MicroStationproducts, which are developed by Bentley Systems, Inc., Exton, Pa. U.S.A., and AutoCAD® products, which are developed by Autodesk, Inc., San Rafael, Calif., U.S.A., are typical of such CAD software, which may be used in the engineering, construction, and operations (ECO) marketplace.

In large design projects, such as skyscrapers, large office complexes and manufacturing plants, hundreds of drawings and models for the electrical, HVAC, plumbing systems etc. are generated using CAD systems. Typically, these large design projects involve a variety of clients, vendors, and internal designers. The clients, vendors, and internal designers may use different CAD systems. For example, a plumbing contractor may use AutoCAD and a design engineer may use MicroStation. Typically, each CAD system uses it own set of graphics primitives and associated objects to represent data. Thus, the different CAD systems use different file formats, for example, MicroStation files are in a DGN format whereas AutoCAD files are in a DWG format. These different file formats are usually not compatible with each other and must be converted into a format acceptable by a particular CAD system in order to share project data and to view and edit models using the different systems.

Current processes for converting and editing data in different file formats are inadequate. Generally, the current process of using one system, a native system, to edit data from a foreign system involves three steps. Here, native system refers to a user's system and foreign system refers to a system not compatible with the user's system. FIG. 1 illustrates the current process for using a native system, such as MicroStation, to edit a file created using a foreign system, such as AutoCAD. Foreign file 1 is created using the foreign system and its data is in a format compatible with the foreign system, a foreign format. Here, since AutoCAD is used as the foreign system, the foreign format is the DWG format. In the first step, foreign file 1 is translated or converted from the foreign format, DWG, into a native format, DGN, used by the native system, MicroStation. The data is now in the native file in a format that can be manipulated by the native system. In the second step, the native system, MicroStation, is used to manipulate or edit the data in the native file. Any changes made by the user are made to the data in the native file as in a normal editing session using the native system. In a third step, the edited native file is translated from the native format DGN, back into to the foreign format, DWG. This translation results in a second file, foreign file 2, in the foreign format. Foreign file 2 is created from the edited file in the native format.

The above approach to converting and editing files in different formats suffers from many drawbacks. For example, for the converting and editing process to be lossless, the native format must be an efficient container for all the data in the foreign file. That is, the native format must be able to accurately reproduce and represent all of the data in the foreign format. Typically this is not the case. There are usually concepts in the foreign system that do not exist in the native system A very simple example of this situation is a foreign system that supports colors and a native system that supports only a single color (monochromatic). Consequently, there is data (colors) in the foreign file that the native system cannot handle and is not carried forward during conversion from the foreign format into the native format. As this data is not present in the native file that is edited in the second step of the current process, this data is not present in foreign file 2 created from the edited native file in the third step. Thus, this data is irretrievably lost. In the example cited above, a design with color data would not only appear without color in the monochromatic system, but upon translation back to the color system, the colors would be lost and the design itself would appear as a single color.

Furthermore, using the current process, there is the potential for concepts to misalign and subsequent losses of information. Concept misalignment can produce subtle losses of data. A foreign system may support very specific geometry types that are not directly supported by the native system, but can be represented with a more general geometry type. Typically, round trip conversion from a specific geometry type to a more general one and back to the specific geometry type causes the entity to be demoted to the more general type. The entity may then appear the same, but its specific classification is discarded. For example, a cone entity in a foreign system may be represented as a general solid body in a native system that does not have a cone entity and then returned to the foreign system as a solid rather than a cone. The result appears the same, but the specificity is discarded.

Just as the native format may not be able to accurately reproduce and represent all the data in the foreign file, as was described above, the foreign format may not be able to accurately reproduce and represent all the data in the native file. For example, during editing of the native file with the native system, a user can typically make changes to the data utilizing all the functionality of the native system. The data can be changed by the native system to have attributes that are not present or representable in the foreign system. Accordingly, when the edited native file is translated into foreign file 2 in the foreign format in the third step of the current process, this data cannot be represented and is again irretrievably lost.

Moreover, two foreign files are present in the current process, foreign file 1 and foreign file 2. The presence of these two similar files creates the potential for the wrong file to be used and for inconsistencies between the files to cause problems.

Consistent, reliable data is necessary for continuous and accurate information flow in the ECO marketplace. Any type of data loss results in delays and errors, increasing the time and expense needed for information processing. In the case of text styles or fonts used for dimensioning, the loss of this data has a tremendous impact on the accuracy of the drawing file itself and the ability to construct from it. Thus, the data loss that occurs using existing systems and methods for converting and editing data is unacceptable. Accordingly, there is a need for a system and method that allows lossless conversion of data. Moreover, data in a foreign format should be able to be modified with a native system that utilizes a native format, without data loss.

### SUMMARY OF THE INVENTION

A technique for allowing converting and/or manipulating data in different formats is provided. Data in a first format is imported into a system. The system converts the data in the first format into a second format that is compatible with the system. The system may then be used to edit or otherwise manipulate the data. To reflect any changes made during editing the data while in the second format, the data in the first format may be directly changed. Preferably, data in the first format that does not have a corresponding container in the second format are preserved. Also, editing changes should be applied only to the individual data in the first format that have been modified.

In an exemplary embodiment, as the data in the first format is imported into the system, a key value is preserved in the second format. In this way, a direct relationship between the data in the first and second formats can be created. During editing, a list of the changes to the data in the second format can be created. These changes may be applied to the data in the first format using the key values as a guide.

According to one embodiment of the invention, a method of editing data in a foreign format with a native system is provided. The data in the foreign format is converted into a native format used by the native system. The converted data may be edited using the native system. The data in the foreign format can be altered directly to reflect the changes made to the converted data during editing.

In a further embodiment, a foreign file including first data in a foreign format is provided. The first data is converted into second data in a native format. Changes made to the second data may be tracked. The tracked changes may be made directly to the first data in the foreign format.

Accordingly, a method and system for converting data between formats is provided. Among other things, the present invention can solve the problem of round trip data loss as data that is not representable in the native format can be preserved. Also, by applying only changes to data that has been changed, attributes of the data in the foreign format may be preserved during editing with the native system.

### BRIEF DESCRIPTION OF THE DRAWINGS

FIG. 1 is a flow diagram of an editing process according to the prior art;

FIG. 2 is a flow diagram of an editing process according to an embodiment of the invention;

FIG. 3 illustrates an example of organization of a file;

FIG. 4 is a flow diagram illustrating a conversion and editing process according to an embodiment of the invention;

FIG. 5 illustrates an example of a file in a first format and a corresponding file in a second format;

FIG. 6 illustrates an example of an edited file in the second format; and

FIG. 7 illustrates changes in the edited file in FIG. 6 applied to a file in the first format.

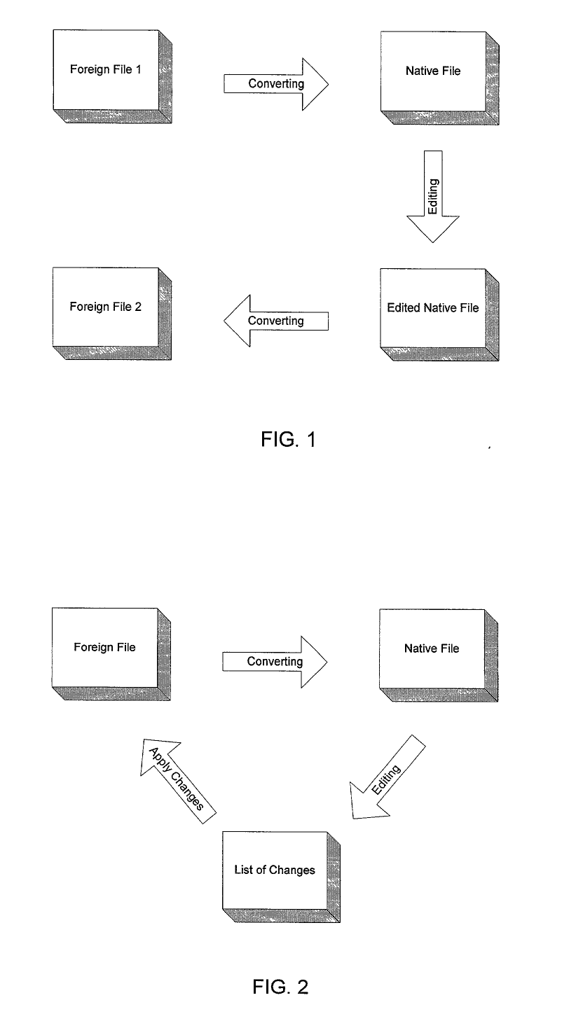

### DETAILED DESCRIPTION OF THE INVENTION

The present invention can provide a method and system for preserving data translated or converted between different formats. Usually, the method is performed using a CPU executing program steps specified by computer readable program code. FIG. 2 illustrates a flow diagram of a method according to an exemplary embodiment of the invention. Assume a user of a native system desires to work with a foreign file containing data in a foreign format. To do so, the foreign file in the foreign format should be converted into a native file in a native format. Some data in the foreign file may not be converted into the native format. This data may include data that cannot be represented in the native format. Any data not converted into the native format should be preserved, preferably in the foreign file. Conversion of the data into the native format allows the data to be manipulated, edited, changed, etc. by the native system. Any alterations made to the data using the native system may be tracked, for example, by creating a list of changes. The foreign file can be updated to reflect these alterations by directly changing the foreign file, rather than by attempting to recreate the foreign file from the altered or edited native file.

Furthermore, the foreign file should still include the data that is not converted into the native format. By directly making changes to the foreign file, the data that cannot be represented by the native system is not lost and is still present in the foreign file. Thus, data that cannot be represented by the native system can be preserved during conversion between different formats and editing. Preferably, the process of applying changes to the foreign file only alters attributes of the data that were changed by the native system, preserving all the foreign attributes of the data.

As data is converted from the foreign system into the native system, a direct relationship between data in the foreign format and data in the native format can be created. The direct relationship can facilitate applying any changes made to the data while in the native format directly to the foreign file. Typically, a key value is used to identify specific data, such as individual entities or components of an engineering drawing, in a file. The direct relationship between data in the foreign format and data in the native format can be created by using the same key value of data in the foreign format for the same data in the native format.

The method and system of the present invention are particularly suited for the CAD and ECO environment and are described in more detail below in that context. However, the invention can be used in any environment where data is converted, translated, or otherwise moved between different formats.

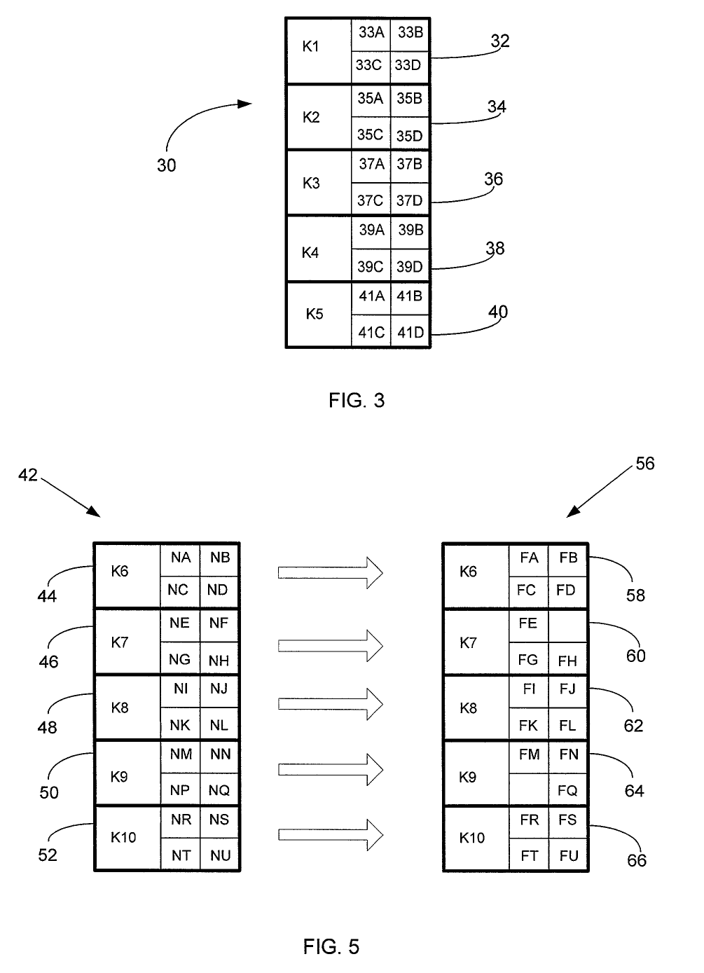

Typically, a project in the ECO environment is composed of a number of models. Models divide the project into logical areas and represent these logical areas. The data for the models is stored in files that are accessed by the CAD systems. FIG. 3 illustrates an example of the organization of data in a file 30 that may be used by a CAD system. Typically, file 30 is comprised of a plurality of entities 32, 34, 36, 38 and 40. The entities 32, 34, 36, 38 and 40 can represent specific elements or components of the model. For example, an entity can represent a door, window, vent, etc. Each entity 32, 34, 36, 38, and 40 may have attributes 33a-33d, 35a-35d, 37a-37d, 39a-39d and 41a-41d that define the characteristics of that entity. These attributes can include both physical and geometric attributes. Physical attributes usually relate to color, etc. whereas geometric attributes usually relate to size, dimensions, etc. Thus, each entity usually has a different set of attributes associated with it. Also, each entity 32, 34, 36, 38, and 40 may have a key value K1-K5, respectively, associated with it. As mentioned above, the key value should be a unique identifier, for example an integer, used to identify each individual entity.

It is desired to edit a foreign file in a foreign format with a native system. As mentioned above, the different CAD systems use different file formats, for example, MicroStation files are in a DGN format whereas AutoCAD files are in a DWG format. In order for the native system to manipulate the data in the foreign format, the data should be converted into the native format used by the native system. However, the foreign file will typically contain data that cannot be represented by the native system. For example, the entities in the foreign file may have attributes that the native system cannot manage. In order to maintain data integrity, these attributes should be preserved during the conversion and editing process. Thus, according to one embodiment of the invention, the attributes that are not converted into or cannot be represented by the native system are preserved and included in any file produced after editing. There a several ways of accomplishing this.

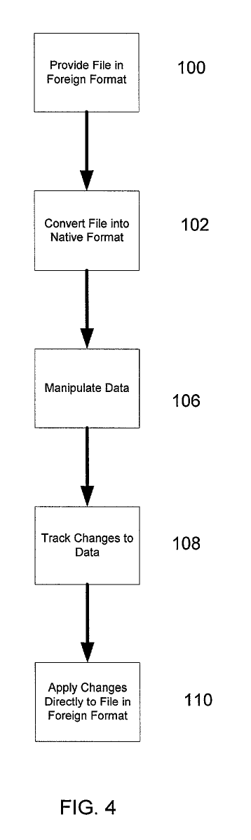

FIG. 4 is a flow diagram of a conversion and editing method according to one embodiment of the invention. In step 100, a foreign file containing data in a foreign format is provided. The data in the foreign file in the foreign format is converted into the native format per step 102. For example, FIG. 5 illustrates foreign file 42 that is converted into the native format and represented by native file 56. Foreign file 42 is comprised of entities 44, 46, 48, 50 and 52. Each of the entities 44, 46, 48, 50 and 52 has a key value K6-K10, respectively, and various attributes associated with it. In this example, entity 44 has attributes NA, NB, NC and ND; entity 46 has attributes NE, NF, NG, and NH; entity 48 has attributes NI, NJ, NK, and NL; entity 50 has attributes NM, NN, NP, and NQ; and entity 52 has attributes NR, NS, NT, and NU. These entities and their attributes can be converted into the native format using a known conversion process. Simple conversion processes are well known to those skilled in the art and are not described in detail here.

Additionally, in order to maintain consistency and prevent errors or misalignment during conversion, a direct relationship between the foreign entities and their native counterparts should be created. This may be done by utilizing a key value present in most file formats. Key values can be used to identify and track an entity as the entity is converted into the native format. The key value can also be used to track any changes that are made to an entity during editing. As mentioned above, the key value may be a unique integer associated with each entity. As entities are imported into the native system, their key values in the foreign format are determined. Identical key values can then be used to identify corresponding entities in the native format. Accordingly, in this example entities 58, 60, 62, 64, and 66 are created in the native file 56 during conversion. Entities 58, 60, 62, 64, and 66 in native file 56 correspond to entities 44, 46, 48, 50, and 52 in the foreign file 42, respectively. To create a direct relationship between the corresponding entities, the key values K6-K10 for entities 44, 46, 48, 50, and 52 in the foreign file 42 may be used for entities 58, 60, 62, 64, and 66 in the native file 56, as is shown in FIG. 5. This consistent keying provides an efficient mechanism to track the entities and changes made to them during an editing session, as described in more detail below.

The attributes associated with each entity in the foreign file should also be associated with the corresponding entity in the native file. Entity 44 has attributes NA, NB, NC, and ND associated with it. Each of these attributes may have a corresponding container in the native format and therefore can be represented by the native format. Thus, when the conversion is performed, these attributes are converted into the native format and represented by attributes FA, FB, FC, and FD. Attributes FA, FB, FC and FD are associated with entity 58 in native file 56, which entity corresponds to entity 44 in the foreign file 42. However, as mentioned above, some attributes of the entities in the foreign file may not be representable in the native format. For example, assume attributes NF and NP of entities 46 and 50, respectively, cannot be accurately represented in the native format. In an exemplary embodiment of the invention, these attributes are not converted and are not associated with corresponding native entities 60 and 64 in native file 56, as is shown in FIG. 5. However, attributes NF and NP should still be maintained in the foreign file 42. Thus, only attributes that can be reproduced in the native format should be converted from the foreign format into the native format. Accordingly, entities 44-52 and their respective attributes are converted using the above procedure and are represented in the native format as entities 58-66 and their respective attributes

After the data has been converted into the native format, the native system can manipulate, change, edit, etc. the data per step 106 of FIG. 4. The foreign file 42 and the native file 56 should be preserved before any changes are made to the data, for example, during editing. Any changes to the data should be tracked, for example, by keeping a list of changes. The changes may be made directly to the foreign file, per steps 108 and 110. Generally, in a CAD system, possible changes to the data include deleting entities, adding entities, and modifying entities. These changes can be made as in a normal editing session using the native system. All or partial functionality of the native system can be provided. As mentioned above, concepts may exist in the native format that are not present in the foreign format. Therefore, if it is known that the foreign system will not support specific concepts present in the native system, the native system may “lock-out” these functions. For example, this may be done by keeping a capabilities mask and disallowing certain tools in the native system that exceed the allowed capabilities.

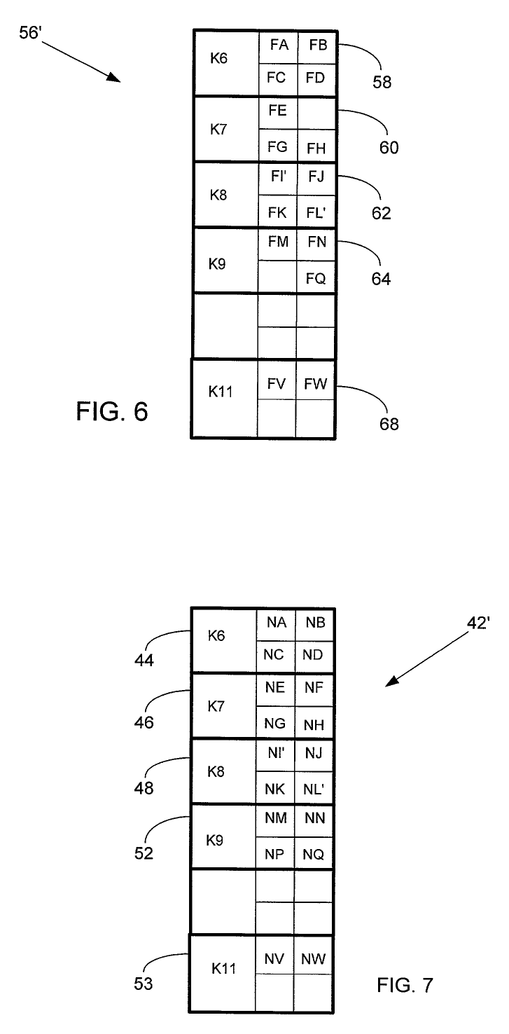

FIG. 6 illustrates native file 56 after some changes have been made to it using the native system. Use of the prime symbol indicates an attribute has been changed. The modification of entities can include making changes to both the geometric and physical attributes of the entities. For example, entity 62 may represent a door having a width, attribute FI, and a color, attribute FL. A user using the native system may modify the width of the door so it can accommodate a wheelchair and may also change the color of the door. Attributes FI and FL should be altered in the native file to reflect these modifications. In addition to being modified, entities may be deleted or added during editing. For example, entity 66 may represent an entity that is no longer needed and is deleted from the model. New entity 68 may be created to represent additional features of the model.

According to an exemplary embodiment, the changes made to the native file 56 are tracked during editing. These changes may then be made directly to the foreign file 42 per step 110 of FIG. 4. This step may be performed by creating a list of the changed entities, determining what changes were made, and applying these changes to the foreign file. For example, when an entity is changed, its key value can be determined. The key values for the changed entity may be added to a “dirty list” that includes the key values of all entities that have been changed. In this example, entities 62, 66, and 68 have been changed and are added to the dirty list. Different specifications for what constitutes a change and different parameters for adding entities to the dirty list may also be used.

In order to determine what changes have been made to the entities in the native file, the native file stored before editing and the native file after editing may be compared with each other. The dirty list may be examined to determine what entities have been changed by the native system. As mentioned above, a copy of the native file before any changes have been made can be maintained. The key values for the changed entities are obtained from the dirty list. The entities corresponding to these key values are retrieved from native files 56 and 56′, which represent the entities in their pre-change and post-change states. To determine what changes have been made, the pre-change entities and post-change entities in these files may be compared to each other. Differences between the entities should indicate any changes made. Following this procedure, in this example entities 62, 66, and 68 in native files 56 and 56′ and are compared to each other. From this comparison, it is evident that attributes FI and FL have been changed. The changes to these attributes are then determined. A change to attributes can be efficiently determined by comparing the memory images of the pre and post changed entity data and detecting a change whenever the memory is not identical.

Additionally, the comparison of the pre-change and post-change native files 56 and 56′ reveals that entity 68 in file 56′ has no corresponding entity in the pre-change file 56. Therefore, it is determined that entity 68 is a newly created entity. The new entity should have a new key value, K11, assigned to it. Typically key values are in assigned in some sequence, for example, increasing integers. The existing key values are examined and entity 68 should be assigned the next key value in sequence. The comparison of the pre-change and post-change native files 56 and 56′ also reveals that entity 66 exists in the pre-change file 56, but not the post-change file 56′. Therefore it is determined that entity 66 has been deleted.

When changes to the native file have been determined, the foreign file can be updated to reflect the changes. This is preferably done by applying the changes directly to the foreign file. In this example, entity 68 has been added. Thus, an entity corresponding to entity 68 is created in foreign file 42 in the foreign format. This can be done by creating a new foreign entity 53 based on the newly created entity 68 in a manner similar to a traditional conversion. Entity 66 has been deleted. The key value K10 for entity 66 is located in the foreign file 42 and the corresponding entity 52 is deleted there. Changes to the foreign file can be made through standard application program interfaces (APIs) such that the modifications look identical to those made directly on the foreign file without any translation or conversion.

Preferably, only those individual entities or attributes that have been changed in the native file are changed in the foreign file. As the same key value is preferably used for both the foreign entities and their corresponding native entities, it is a simple procedure to locate the entities in the foreign file that are to be changed. Using the above procedures, for example, the changes made to native file 56 are applied to foreign file 42, resulting in modified foreign file 42′ shown in FIG. 7. Note that entities 46 and 50 in the foreign file 42′ also contain attributes NI and NP that could not be represented in the native format. Although, these attributes were not converted into the native format, they should have been preserved in the foreign file 42. Thus, any data that was not converted from the foreign file into the native format may be preserved and not changed. Consequently, foreign file 42′ contains both attributes that have been modified in the native system, such as attributes FI and FL in entity 48 and attributes that cannot be represented in the native system, such as attributes NF and NP in entities 46 and 50. Accordingly, no data is lost during conversion between formats.

According to one of the more detailed features of an embodiment of the invention, relationships between entities in a file may be altered based on the editing. In a CAD model, the different entities can have relationships with each other. That is, different entities can be physically connected or otherwise dependent on each other. During editing of the file, these relationships may be affected. The present invention can provide a way to maintain these relationships after editing. The relationships between different entities may be tracked by storing a key or handle in an entity of entities that entity depends on. The foreign file is examined to determine this handle. The present invention can go through the foreign file to handle remapping the relationships. This remapping is a relatively common occurrence for systems that use handles to identify entities. Remapping may be necessary when data from different designs is merged, therefore application program interfaces (APIs) for handling this remapping are typically provided.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

I claim:

1. A method of editing data in a foreign format with a native system, comprising:
converting the data in the foreign format into a native format used by the native system;
editing the converted data with the native system; and
altering directly the data in the foreign format to reflect changes made to the converted data during editing.

2. The method according to claim 1, further comprising creating a list of changes made to the converted data during editing.

3. The method according to claim 2, wherein the altering step comprises making the changes in the list directly to the data in the foreign format.

4. The method according to claim 1, further comprising:
maintaining a first representation of the converted data in the native format before editing;
maintaining a second representation of the converted data in the native format after editing; and
comparing the first and second representations to determine the changes made to the converted data.

5. The method according to claim 1, further comprising converting only data in the foreign format that has a corresponding container in the native format.

6. The method according to claim 1, further comprising preserving data in the foreign format that cannot be represented in the native format.

7. The method according to claim 1, wherein the altering step is performed after editing is completed.

8. The method according to claim 1, wherein the changes included at least one of addition, deletion, or modification of the data.

9. The method according to claim 1, further comprising creating a representation of the converted data in memory only.

10. The method according to claim 1, further comprising deleting the converted data when editing is completed.

11. A method of editing data in a foreign format with a native system, comprising:
a) receiving a foreign file including first data in a foreign format;
b) converting the first data into second data in a native format;
c) tracking changes made to the second data; and
d) directly making the tracked changes to the first data in the foreign format.

12. The method according to claim 11, wherein the first and second data comprise a plurality of entities.

13. The method according to claim 12, further comprising creating a direct relationship between entities in the first data and corresponding entities in the second data.

14. The method according to claim 12, wherein each entity is associated with a key value.

15. The method according to claim 14, further comprising:
determining the key value for each entity in the first data; and
using the same key value as the first data to identify corresponding entities in the second data.

16. The method according to claim 15, wherein steps c) and d) comprise:
creating a list of the key values for entities in the second data that have been changed;
locating entities in the first data corresponding to the entities in the second data that have been changed based on the key value; and
making the tracked changes directly to the corresponding entities in the first data.

17. The method according to claim 11, further comprising:
maintaining a representation of each entity in the second data in the native format before editing;
maintaining a representation of each entity in the second data in the native format after editing; and
comparing the representations to determine changes made to the entities.

18. The method according to claim 11, wherein only entities that have been changed in the second data are changed in the first data.

19. The method according to claim 15, wherein the changes to the second data comprise at least one of deleting an entity, adding a new entity, changing an existing entity.

20. The method according to claim 19, wherein the change comprises deleting an entity and step d) comprises locating and deleting an entity with a corresponding key value in the foreign file and deleting it.

21. The method according to claim 19, wherein the change comprises adding a new entity and step d) comprises creating a representation of the new entity in the foreign format, determining a key value for the new entity, and associating the representation with the new key value.

22. The method according to claim 11, wherein the second data in the native format is created in memory only.

23. The method according to claim 22, further comprising deleting the second data from memory after an editing session ends.

24. The method according to claim 11, further comprising:
determining a mapping between different entities in the first data; and
altering the mapping of the entities in the first data based on the changes.

25. A method for lossless manipulation of data between different formats, comprising:
receiving a first file containing data in a first format;
converting the data in the first file into a second format;
preserving data in the first file that cannot be represented in the second format;
changing the data while it is in the second format; and
producing a file in the first format including the preserved data and the changes to the data.

26. The method according to claim 25, wherein the file is produced by directly applying the changes made to the data while the data is in the second format to the first file.

27. The method according to claim 25, wherein the file is produced by converting the changed data in the second format into the first format and importing the preserved data into the converted, changed data.

28. A method for converting data between different formats, comprising:
providing data in a first format, the data including elements;
determining a first group of the elements that cannot be represented in a second format and a second group of elements that can be represented in the second format;
converting the second group of elements into the second format; and
preserving the first group of elements.

29. The method according to claim 28, further comprising editing the data while it is in the second format.

30. The method according to claim 29, further comprising tracking changes made to the data while editing.

31. The method according to claim 30, further comprising altering directly the data in the first format to reflect the tracked changes, wherein the data in the first format after altering includes the preserved first group of elements.

32. A computer useable information storage medium storing computer readable program code means for causing a computer to perform the steps of:
a) receiving a first file containing first data in a first format;
b) converting the first data into second data in a second format;
c) changing the second data;
d) tracking changes made to the second data; and
e) directly altering the first data to reflect the tracked changes to the second data.

33. The computer useable information storage medium according to claim 32, wherein the first and second data comprise a plurality of entities.

34. The computer useable information storage medium according to claim 33, wherein the steps further comprise creating a direct relationship between entities in the first data and corresponding entities in the second data.

35. The computer useable information storage medium according to claim 33, wherein each entity is associated with a key value.

36. The computer useable information storage medium according to claim 35, wherein the steps further comprise:
determining the key value for each entity in the first data; and
using the same key value as the first data to identify corresponding entities in the second data.

37. The computer useable information storage medium according to claim 32, wherein steps d) and e) comprises:
creating a list of the key values for entities in the second data changed during editing;
locating the corresponding entity in the first data based on the key value; and
making the change directly to the corresponding entity in the first data.

38. The computer useable information storage medium according to claim 32, wherein the steps further comprise:
maintaining a representation of each entity in the second data in the native format before editing;
maintaining a representation of each entity in the second data in the native format after editing; and
comparing the representations to determine changes made to the entities.

39. The computer useable information storage medium according to claim 32, wherein the steps further comprise creating a representation in the native format in memory only.

40. The computer useable information storage medium according to claim 39, wherein the steps further comprise deleting the representation after an editing session ends.

41. The computer useable information storage medium according to claim 32, wherein the steps further comprise:
determining a relationship between entities in the first data;
determining a mapping between the entities in the first data; and
altering the mapping of the entities in the first data based on the editing session, if necessary.

42. The computer useable information storage medium according to claim 32, wherein the steps further comprise preserving in the first file first data that is not converted into the second data.
